(19) United States
(12) Patent Application Publication
(10) Pub. No.: US 2026/0116391 A1
(43) Pub. Date: Apr. 30, 2026

(54) CONTROL DEVICE

(71) Applicant: TOYOTA JIDOSHA KABUSHIKI KAISHA, Toyota-shi (JP)

(72) Inventor: Hiroyuki NISHIMURA, Toyota-shi (JP)

(73) Assignee: TOYOTA JIDOSHA KABUSHIKI KAISHA, Toyota-shi (JP)

(21) Appl. No.: 19/226,503

(22) Filed: Jun. 3, 2025

(30) Foreign Application Priority Data
Oct. 25, 2024 (JP) 2024-188313

(51) Int. Cl. B60W 40/06

(52) U.S. Cl. CPC B60W 40/06; B60W 2420/40; B60W 2555/20

(57) ABSTRACT

The control device includes an acquisition unit configured to acquire a detection result of a sensor that includes a transmitter configured to irradiate a road surface of a road on which a host vehicle is traveling with a terahertz wave, and a receiver configured to receive the terahertz wave reflected from the road surface, and a determination unit configured to determine a frozen state of the road surface based on the acquired detection result.

### CROSS-REFERENCE TO RELATED APPLICATION

This application claims priority to Japanese Patent Application No. 2024-188313 filed on Oct. 25, 2024. The disclosure of the above-identified application, including the specification, drawings, and claims, is incorporated by reference herein in its entirety.

### BACKGROUND

### 1. Technical Field

The present disclosure relates to a technical field of a control device that controls a vehicle.

### 2. Description of Related Art

An example of such a device that has been proposed is a device that predicts the possibility of road freezing from traffic information and weather information (see Japanese Unexamined Patent Application Publication No. 2006-228020 (JP 2006-228020 A)).

### SUMMARY

There is room for improvement in the accuracy of predicting the possibility of road freezing in the technique described in JP 2006-228020 A.

The present disclosure has been made in view of the above issue, and an object of the present disclosure is to provide a control device capable of detecting road freezing with relatively high accuracy.

A control device according to an aspect of the present disclosure includes: an acquisition unit configured to acquire a detection result of a sensor that includes a transmitter configured to irradiate a road surface of a road on which a host vehicle is traveling with terahertz waves, and a receiver configured to receive terahertz waves reflected from the road surface; and a determination unit configured to determine a frozen state of the road surface based on the acquired detection result.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration of a control device according to an embodiment; and

FIG. 2 is a flowchart showing an operation of the control device according to the embodiment.

### DETAILED DESCRIPTION OF EMBODIMENTS

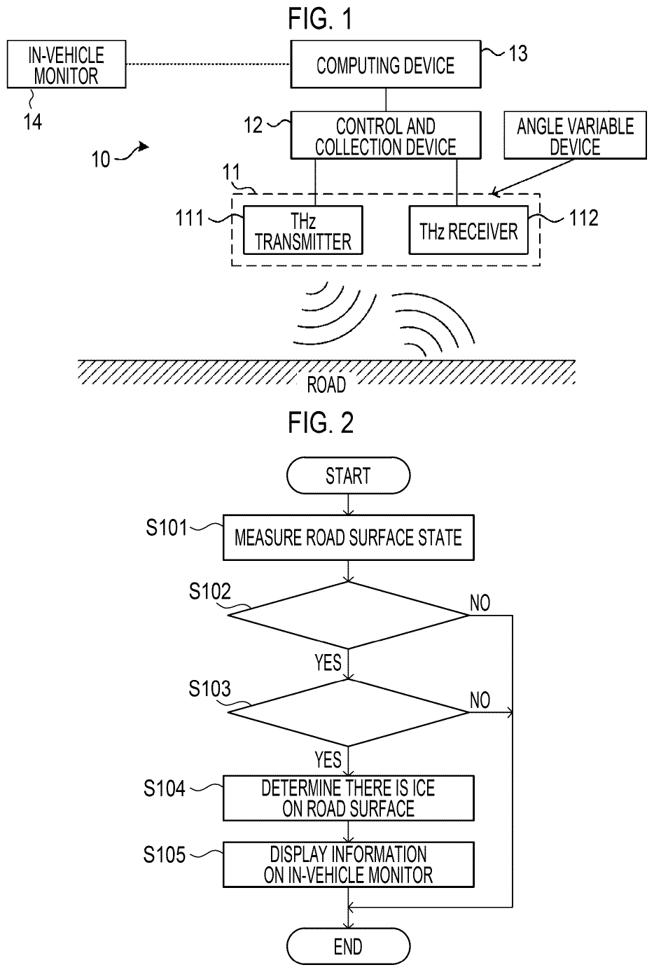

An embodiment of a control device will be described with reference to FIGS. 1 and 2.

### Configuration of Control Device

A configuration of a control device 10 according to an embodiment will be described with reference to FIG. 1. In FIG. 1, the control device 10 is mounted on the vehicle 1. The control device 10 includes a sensor 11, a control and collection device 12, a computing device 13, and an in-vehicle monitor 14. The sensor 11 includes a transmitter 111 for terahertz waves and a receiver 112 for terahertz waves.

The control and collection device 12 controls the transmitter 111 to irradiate the road surface of the road on which the vehicle 1 is traveling with the terahertz waves. The receiver 112 receives at least a part of the terahertz waves reflected from the road surface. The control and collection device 12 collects detection information (that is, data) on the detection result of the receiver 112. In other words, the control and collection device 12 acquires the detection result of the sensor 11.

The control and collection device 12 controls the transmitter 111 to irradiate the road surface with the first terahertz wave having the first frequency and the second terahertz wave having the second frequency different from the first frequency. Here, the reflectance of the first terahertz wave from the wet road surface is greater than the reflectance of the first terahertz wave from the frozen road surface. The reflectance of the first terahertz wave from the wet road surface is approximately the same as the reflectance of the first terahertz wave from the dry road surface. The reflectance of the second terahertz wave from the wet road surface is smaller than the reflectance of the second terahertz wave from the frozen road surface. The reflectance of the second terahertz wave from the frozen road surface is smaller than the reflectance of the second terahertz wave from the dry road surface.

The computing device 13 may include, for example, at least one of a central processing unit (CPU) and a graphics processing unit (GPU). The computing device 13 acquires the detection information from the control and collection device 12. The computing device 13 determines the frozen state of the road surface based on the detection information. When the computing device 13 determines that the road surface is frozen, the in-vehicle monitor 14 notifies the user of the vehicle 1 that the road surface is frozen.

### Operation of Control Device

Next, the operation of the control device 10 will be described with reference to the flowchart of FIG. 2. In FIG. 2, the control device 10 measures the road surface state by using the sensor 11 (S101). Specifically, the control and collection device 12 controls the transmitter 111 to irradiate the road surface of the road on which the vehicle 1 is traveling with the terahertz waves, and collects detection information on the detection result of the receiver 112.

The computing device 13 determines whether the reflectance of the first terahertz wave based on the detection information is smaller than a first predetermined value (S102). As described above, the reflectance of the first terahertz wave from the wet road surface is greater than the reflectance of the first terahertz wave from the frozen road surface. The first predetermined value may be a value between the reflectance of the first terahertz wave from the wet road surface and the reflectance of the first terahertz wave from the frozen road surface. The reflectance of the terahertz waves may be calculated based on the intensity of the terahertz waves transmitted from the transmitter 111 and the intensity of the terahertz waves received by the receiver 112.

In the process of S102, when it is determined that the reflectance of the first terahertz wave is not smaller than the first predetermined value (S102: No), the operation shown in FIG. 2 ends. In this case, the computing device 13 may determine that the road surface is not frozen.

In the process of S102, when it is determined that the reflectance of the first terahertz wave is smaller than the first predetermined value (S102: Yes), the computing device 13 executes the process of S103. S103 is a process of determining whether the reflectance of the second terahertz wave based on the detection information is smaller than a second predetermined value and greater than a third predetermined value (S103). As described above, the reflectance of the second terahertz wave from the frozen road surface is smaller than the reflectance of the second terahertz wave from the dry road surface. The second predetermined value may be a value between the reflectance of the second terahertz wave from the frozen road surface and the reflectance of the second terahertz wave from the dry road surface. In addition, the reflectance of the second terahertz wave from the wet road surface is smaller than the reflectance of the second terahertz wave from the frozen road surface. The third predetermined value may be a value between the reflectance of the second terahertz wave from the wet road surface and the reflectance of the second terahertz wave from the frozen road surface.

In the process of S103, when it is determined that the reflectance of the second terahertz wave is not smaller than the second predetermined value, the operation shown in FIG. 2 ends. Alternatively, in the process of S103, when it is determined that the reflectance of the second terahertz wave is not greater than the third predetermined value (S103: No), the operation shown in FIG. 2 ends. In this case, the computing device 13 may determine that the road surface is not frozen.

In the process of S103, there is a case where it is determined that the reflectance of the second terahertz wave is smaller than the second predetermined value and greater than the third predetermined value (S103: Yes). In this case, the computing device 13 determines that the road surface is frozen (in other words, there is ice on the road surface) (S104). The computing device 13 controls the in-vehicle monitor 14 to display the information indicating that the road surface is frozen (S105). After the process of S103, the process of S102 may be performed.

### Technical Effect

The control device 10 measures the road surface state by using the terahertz waves. For example, the control device 10 can detect the freezing of the road surface with high accuracy as compared with a case where the road surface state is predicted from the traffic information and the weather information.

### Modification

By using the reflectance of the first terahertz wave and the second terahertz wave described above, it is possible to determine the frozen road surface as well as the dry road surface and the wet road surface. The computing device 13 may determine the road surface state based on the detection result of the sensor 11. The computing device 13 may control the behavior of the vehicle 1 based on the determined road surface state. For example, the computing device 13 may set an appropriate tire drive torque based on the determined road surface state. For example, the computing device 13 may activate the safety function of the vehicle 1 to avoid at least one of sudden braking and sudden steering based on the determined road surface state. The computing device 13 according to the modification may be implemented by an electronic control unit (ECU) for controlling the vehicle 1.

The computing device 13 may transmit information indicating that the road surface is frozen to the road management center by using the communication function of the vehicle 1. In this case, the management center may distribute the information indicating that the road surface is frozen to other vehicles present in the predetermined range including the position of the vehicle 1.

Aspects of the disclosure derived from the embodiments and the modifications described above will be described below.

A control device according to an aspect of the disclosure includes an acquisition unit configured to acquire a detection result of a sensor that includes a transmitter configured to irradiate a road surface of a road on which a host vehicle is traveling with terahertz waves, and a receiver configured to receive terahertz waves reflected from the road surface. In addition, the control device according to an aspect of the disclosure includes a determination unit configured to determine a frozen state of the road surface based on the acquired detection result. In the embodiment described above, the “control and collection device 12” corresponds to an example of the “acquisition unit”, and the “computing device 13” corresponds to an example of the “determination unit”.

In an example of the control device, the transmitter may be configured to irradiate the road surface with a first terahertz wave having a first frequency and a second terahertz wave having a second frequency different from the first frequency.

In this case, the reflectance of the first terahertz wave from the wet road surface may be greater than the reflectance of the first terahertz wave from the frozen road surface. In addition, the reflectance of the second terahertz wave from a wet road surface may be smaller than the reflectance of the second terahertz wave from a frozen road surface.

In another example of the control device, the control device may further include a notification unit configured to notify a user of the vehicle that the road surface is frozen when the determination unit determines that the road surface is frozen. In the embodiment described above, the “in-vehicle monitor 14” corresponds to an example of the “notification unit”.

The present disclosure is not limited to the embodiments described above, and may be modified as appropriate within a scope that does not depart from the gist or the idea of the disclosure that can be read from the entirety of the claims and specification, and a control device with such a modification is also included in the technical scope of the disclosure.

What is claimed is:

1. A control device comprising:
an acquisition unit configured to acquire a detection result of a sensor that includes a transmitter configured to irradiate a road surface of a road on which a host vehicle is traveling with terahertz waves, and a receiver configured to receive terahertz waves reflected from the road surface; and
a determination unit configured to determine a frozen state of the road surface based on the acquired detection result.

2. The control device according to claim 1, wherein the transmitter is configured to irradiate the road surface with a first terahertz wave having a first frequency and a second terahertz wave having a second frequency different from the first frequency.

3. The control device according to claim 2, wherein:
a reflectance of the first terahertz wave from a wet road surface is greater than a reflectance of the first terahertz wave from a frozen road surface; and
a reflectance of the second terahertz wave from a wet road surface is smaller than a reflectance of the second terahertz wave from a frozen road surface.

4. The control device according to claim 1, further comprising a notification unit configured to notify a user of the host vehicle that the road surface is frozen when the determination unit determines that the road surface is frozen.
